(19) United States
(12) Patent Application Publication
(10) Pub. No.: US 2015/0044971 A1
(43) Pub. Date: Feb. 12, 2015

(54) Generator Control Device

(71) Applicants: Thomas Dippl, Pressath (DE); Günther Gambke, Weidenberg (DE); Helmut Gollwitzer, Erbendorf (DE); Sultan Haider, Erlangen (DE); Matthias Weig, Marktredwitz (DE)

(72) Inventors: Thomas Dippl, Pressath (DE); Günther Gambke, Weidenberg (DE); Helmut Gollwitzer, Erbendorf (DE); Sultan Haider, Erlangen (DE); Matthias Weig, Marktredwitz (DE)

(21) Appl. No.: 14/455,441

(22) Filed: Aug. 8, 2014

(30) Foreign Application Priority Data
Aug. 8, 2013 (DE) 102013215702.9

(51) Int. Cl. H04W 4/00

(52) U.S. Cl. CPC H04W 4/008
USPC 455/41.3

(57) ABSTRACT

A generator control device for a system generating x-radiation, and a corresponding operating method, arrangement and system are provided. The operating method for the generator control device includes providing configuration data for the system that generates the x-radiation via at least one first communication interface. The method also includes receiving at least one signal for triggering generation of the x-radiation via a second communication interface or the first communication interface. The method includes receiving information for displaying image data from a unit receiving the x-radiation, and providing at least one smart device with the information via a further communication interface.

This application claims the benefit of DE 10 2013 215 702.9, filed on Aug. 8, 2013, which is hereby incorporated by reference in its entirety.

### BACKGROUND

The present embodiments relate to a generator control device for a system generating x-radiation and to associated operating methods, arrangements and systems.

Monolithic, closed application structures have proved to be too inflexible with respect to the dynamic changes in the healthcare markets. The possibility of being able to gradually introduce software and hardware modules and of therefore enabling integration in existing IT landscapes is desirable. It is advantageous for the personnel to be gradually introduced to new challenges in information processing. An open architecture makes it possible to integrate third-party systems immediately or at a subsequent time.

In developing markets in which mobile x-ray machines in the lower price segment are often used, only very simple user interfaces may be present for reasons of costs. As a result, it is difficult for the user to select the correct operating mode/setting or configuration in order to achieve the optimum examination result. The user knowledge tends to be lower in regions that primarily use machines in the lower price segment than in established regions.

In the lower price segment, the monitors that are used for x-ray imaging may still be CRT monitors that do not display an image as well as modern TFT or LED screens, for example.

As a result, patients may be loaded with an unnecessary dose as a result of repeated recordings, incorrect diagnoses may be made, or inappropriate treatments may be carried out on account of an insufficient image quality.

The problem of providing the user with a suitable user interface may be solved using system-internal electronics/computers. The user is therefore offered different operating modes for different applications, the pre-settings of which may be stored for the generator for generating x-radiation. The user interface may include selection buttons all the way to an animated touch display/panel.

These solutions are based on the fact that computer/logic power is provided in the x-ray system in addition to the generator. Even in simple systems, a considerable amount of electronics is used to provide a user interface.

A CPU that controls both the generator and the user interface may, for example, be used. The system manufacturer may therefore implement the user interface without a separate CPU and may save costs. However, only the simplest operating mode may be implemented thereby.

Flat screens (e.g., TFT) or CRT monitors may be used to display the x-ray images. In most known systems, an image system for preprocessing (e.g., post processing=subsequent processing) and storage is interposed between the detector and monitors. Overview of the possible solution approaches:

FIGS. 1a, 1b, and 1c show a system S or an arrangement having a user interface UI, a system controller ST, a generator G, an x-ray detector D, an image system B and one or more monitors M. FIGS. 1a, 1b, and 1c illustrate different variants of the coupling of the system components and different ways in which the components communicate with one another. Signals may be interchanged. Data may be transmitted via a bus (e.g., a data bus). Monitors M may be connected to the image system B via a digital or analog connection.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an improved user interface is provided.

In one embodiment, a generator control device for a system generating x-radiation includes a first communication interface for receiving configuration data for the system generating the x-radiation. A second communication interface or the first communication interface receives at least one signal for triggering generation of the x-radiation.

In one embodiment, a third communication interface to a unit that receives the x-radiation and provides information for displaying image data for at least one smart device is provided.

Smartphones, PDAs, tablets and conventional computers etc. with or without a touchscreen may be provided, for example, as smart devices.

Another aspect is a system or an arrangement having a generator control device, a system generating x-radiation, a unit for transmitting a signal for triggering the generation of the x-radiation, and at least one smart device for which information for displaying the image data, which is provided by the unit receiving the x-radiation.

The arrangement may also have a unit that receives the x-radiation.

The generator control device may provide the information for displaying the image data, which is provided by the unit receiving the x-radiation, for at least one smart device and/or other devices as well.

The generator control device may be characterized by a further communication interface that is used to provide the information for displaying the image data, which is provided by the unit receiving the x-radiation, for at least one smart device and/or computer.

The arrangement has, for example, devices or modules for carrying out the operating method that may each be in the form of hardware, firmware, and/or software or computer programs.

An operating method for such a generator control device is also provided.

The operating method may be implemented in the form of an application (app) on a smart device. The operating method may likewise be implemented in the form of program code on the generator control unit.

The system or the arrangement and the communication devices and computer programs may be accordingly designed or developed like the method.

The present embodiments have the following advantages.

The system controller and the image system are moved from the system architecture to the generator controller or partially to a smart device. The system may retain the switching contact or pushbutton contact for triggering the radiation, which may be provided for safety reasons. The system is more economical as a result of the present embodiments since the user's hardware may be used, especially in developing countries.

As a result of the fact that the user interface is implemented in the form of a software solution (e.g., app or web interface), the user interface may be intuitively operated. Assistance and operating assistants may be implemented. There is no need for any additional training of the users for the operating concept of a smart device since this concept is generally known. Configuration data or parameters for the x-radiation may be provided to the user (e.g., organ programs, user assistance programs, etc.) and may be set by the user. Since the screen resolution and contrast of modern smart devices have become high, adequate image quality when displaying the images is also provided. The amount of maintenance is reduced since only updates for apps and common operating systems such as Android, Windows 8 or iOS are to be maintained. The maintenance of apps for the smart devices is dispensed with when using a web interface. Another advantage is that information and images are already on a medium that enables simple distribution to further users.

The present embodiments may also be provided for further stationary or mobile x-ray systems or other imaging methods.

### BRIEF DESCRIPTION OF THE DRAWINGS

FIGS. 1a, 1b, and 1c show a system or an arrangement; and

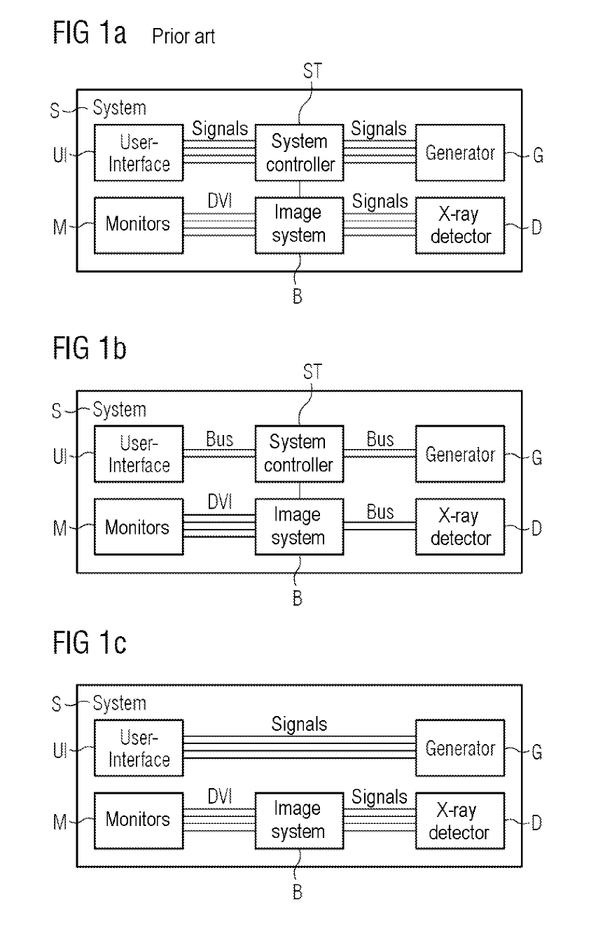

FIGS. 2 and 3 show embodiments of the system or arrangement.

### DETAILED DESCRIPTION

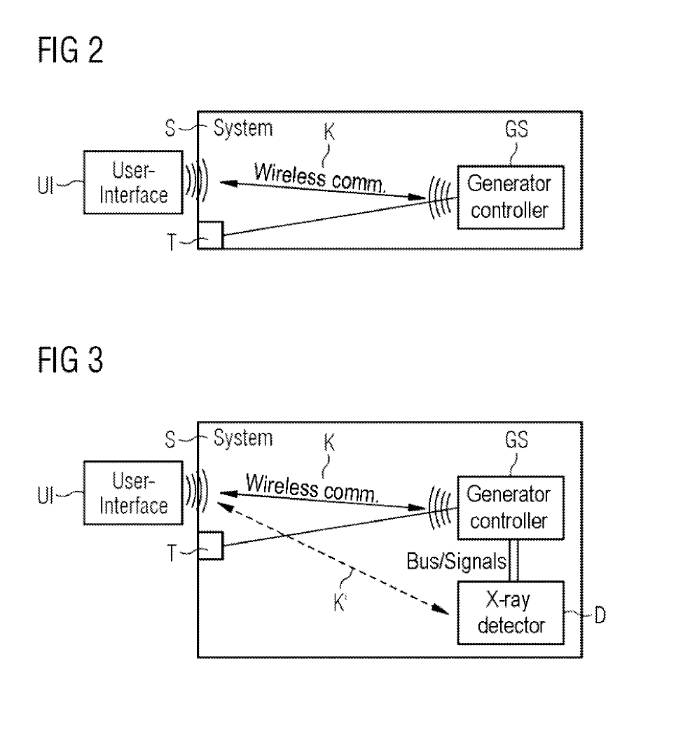

FIGS. 2 and 3 show one embodiment of a system S or an arrangement having a user interface UI, a generator controller GS and a communication interface K between the user interface UI and the generator controller GS. FIGS. 2 and 3 also show a pushbutton T that may be used for beam triggering and is connected to the generator controller GS. Alternatively, triggering via the user interface may also be provided. FIG. 3 also shows an x-ray detector D that is connected to the generator controller via a bus bus/signals and may communicate with the user interface UI via a further communication interface K′.

The communication interfaces K and K′ may be distinguished by a radio link that is wireless. Standardized transmission methods (e.g., Bluetooth, DECT, WLAN/WIFI, GSM, 3G, UMTS, HSDPA or 4G and/or LTE and others) may be provided for the radio link. Smart devices (e.g., smartphones, PDAs, tablets and conventional computers) with or without a touchscreen may be provided as the user interface.

Radiation may be triggered using the pushbutton in the system. Alternatively, radiation may be triggered via the user interface. If the radiation is triggered via the user interface (e.g., in an app or a web interface), communication between the UI and the generator controller GS may be carried out via the same communication interface K or a separate communication interface.

An explicit system controller is therefore obsolete. The generator control device has an autonomous controller. The generator control device sets up a communication channel or connection to the smart device in order to interchange the necessary configuration data or parameters.

Wireless technologies (e.g., WLAN or Bluetooth) that enable encrypted transmission may be provided as the communication channel between the generator control device and the smart device. An application (e.g., app) or a web interface is started on the smart device and is used as a user interface for inputs and outputs and manages the data traffic to the generator control device. All operating modes and feedback data from the generator control device and the x-ray detector may therefore be displayed in a user-friendly interface.

On account of the already available high resolutions, contrast and brightness, the smart device may also be used as a diagnostic display. The app not only handles the user inputs but also displays the x-ray(s). A two-monitor or two-display solution with two or more smart devices in a master/slave mode or with one smart device and further monitor(s) (e.g., wired monitors) on the generator controller may also be provided. In this case, smart devices may be used as the user interface and for display, and the further devices may be used only for display. A live image and a stored image may therefore be displayed beside one another, for example. The image information may be transmitted via the communication channel that has already been established for the user interface. The generator control device operates as a type of relay station. A separate communication channel from the x-ray detector to the smart device may also be provided. The smart device may be provided by the user and is supplied with the app during system start-up and is linked to the system. Only a holding frame and a power supply for the smart device may be provided on the system side.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A generator control device for a system generating x-radiation, the generator control device comprising:
a first communication interface configured to receive configuration data for the system generating the x-radiation; and
a second communication interface or the first communication interface configured to receive at least one signal for triggering generation of the x-radiation.

2. The generator control device of claim 1, further comprising a third communication interface to a unit configured to receive the x-radiation and provide information for displaying image data for at least one smart device.

3. The generator control device of claim 2, wherein the generator control device is configured to provide the information for displaying the image data, which is provided by the unit receiving the x-radiation, for the at least one smart device via the first communication interface, the second communication interface, or the first communication interface and the second communication interface.

4. The generator control device of claim 1, further comprising a further communication interface used to provide information for displaying the image data, which is provided by a unit receiving the x-radiation, for at least one smart device.

5. An arrangement comprising:
a generator control device;
a system operable to generate x-radiation in response to the generator control device;
a unit configured to transmit a signal for triggering the generation of the x-radiation; and
at least one smart device configured to receive information for displaying image data.

6. The arrangement of claim 5, further comprising a unit configured to receive the x-radiation.

7. The arrangement of claim 6, wherein the information for displaying the image data, which is providable by the unit configured to receive the x-radiation, is passable to the at least one smart device via the generator control device.

8. The arrangement of claim 6, further comprising a further communication interface operable to provide the information for displaying the image data, which is providable by the unit configured to receive the x-radiation, for the at least one smart device.

9. An operating method for a generator control device, the operating method comprising:
providing configuration data for a system that generates x-radiation via at least one first communication interface;
receiving at least one signal for triggering generation of the x-radiation via a second communication interface or the first communication interface;
receiving information for displaying image data from a unit receiving the x-radiation; and
providing at least one smart device with the information.

10. The method of claim 9, wherein providing the at least one smart device with the information comprises providing the at least one smart device with the information via a further communication interface.
